(19) United States
(12) Patent Application Publication
(10) Pub. No.: US 2012/0061298 A1
(43) Pub. Date: Mar. 15, 2012

(54) IMPROVED METHOD AND APPARATUS FOR FROTH FLOTATION IN A VESSEL WITH AGITATION

(75) Inventor: Graeme John Jameson, New Lambton (AU)

(73) Assignee: NEWCASTLE INNOVATION LIMITED, Callaghan, New South Wales (AU)

(21) Appl. No.: 13/321,667

(22) PCT Filed: May 26, 2009
(86) PCT No.: PCT/AU2009/000653

§ 371 Date: Nov. 21, 2011

(51) Int. Cl. B03D 1/02; B03D 1/16; B03D 1/001

(52) U.S. Cl. 209/166; 209/164; 209/169

(57) ABSTRACT

A method of separating mixed particles in a flotation cell uses a fluidized bed within the cell where particles are fluidized in a quiescent zone by liquid moving upwardly through the fluidized bed. The fluidizing liquid may be provided by the feed or by recycling liquid from upper parts of the cell such as from the disengagement zone. Bubbles are introduced into the lower part of the cell through a mechanical impeller which also breaks up any channels in the mixing zone, or by separate aeration in the bottom of the cell or by introduction through a recycle pipe.

### FIELD OF THE INVENTION

This invention relates to the froth flotation process for the separation of particles. In particular, it relates to improving the recovery of coarse particles by froth flotation.

### BACKGROUND OF THE INVENTION

The flotation process is used extensively in industry to separate valuable particles from particles of waste material. In the minerals industry for example, rock containing a valuable component is finely ground and suspended in water. Reagents are generally added that attach selectively to the valuable particles making them water repellent or non-wetting (hydrophobic), but leaving the unwanted particles in a wettable (hydrophilic) state. Bubbles of air are introduced into the suspension in a vessel or cell. The non-wettable particles attach to the bubbles, and rise with them to the surface of the suspension where a froth layer is formed. The froth flows out of the top of the cell carrying the flotation product. The particles that did not attach to bubbles remain in the liquid and are removed as tailings. Frothers may be added, that assist in the creation of a stable froth layer.

Machines for the flotation process are known in prior art. Typically, the machine consists of an agitator or impeller mounted on a central shaft and immersed in a suitably conditioned pulp in a flotation cell. The rotating impeller creates a turbulent circulating flow within the cell that serves to suspend the particles in the pulp and prevent them from settling in the vessel; to disperse a flow of gas that is introduced into the cell into small bubbles; and to cause the bubbles and particles to come into intimate contact, thereby allowing the hydrophobic particles in the pulp to adhere to the bubbles. The bubbles and attached particles float to the surface of the cell where they form a froth layer that flows over a weir, carrying the flotation product. The impeller customarily is surrounded by a stator that assists in the creation of a highly sheared environment in the vicinity of the impeller, and also prevents the formation of a vortex or whirlpool in the liquid in the cell. Flotation machines of this type are known as mechanical cells. Typical mechanical cells are described in textbooks such as Wills' Mineral Processing Technology, 7th edition, T. Napier-Munn ed., Elsevier, N.Y., 2007.

It is well known that the recovery of particles in mechanical cells decreases as the particle size increases. In mechanical cells, eddies are created in the liquid by the turbulent agitation, and when the intensity of the turbulence in the cell increases, eddies of greater rotational speed are formed. The gas bubbles move to the centre of eddies and rotate with them. Greater rotational speeds lead to larger centrifugal forces that tend to cause the particles to detach from the bubbles. Accordingly, in mechanical cells in current practice, there is an inherent limitation in the maximum size of particles that can be recovered efficiently. An inherent difficulty with mechanical cells is that as the particle size increases, greater turbulent energy must be supplied to keep the particles in suspension in the cell, thereby leading to less and less likelihood that the coarse particles will be able to remain attached to the bubbles.

Particles whose diameter is at or above the maximum size that can be treated efficiently in mechanical flotation cells are regarded as ‘coarse’ particles. The meaning of the term ‘coarse particles’ depends on the density of the particles. For sulfide and oxide minerals, where the density may be in the range 2500 to 7000 kg/m³, particles larger than 100 to 150 microns in diameter are generally regarded as coarse particles. For lighter substances like coal, whose density is in the range 1200 to 1800 kg/m³, coarse particles are those above 250 to 500 microns.

The centrifugal forces acting on particles suspended in a slurry can be related to the local shear rate or local turbulent intensity in the flotation cell. For purposes of definition, general terms such as the level of turbulence, the turbulent intensity, the energy dissipation rate or the average shear rate are assumed here to be equivalent to the specific rate of input of mechanical energy (power per unit volume) into the working region of the flotation cell, or the rate of dissipation of mechanical energy per unit volume of liquid in the active region. As an example, the specific power input into flotation cells in current practice is typically of the order of 3 kW per cubic metre of working volume in the cell. However, the most active region of a mechanical flotation cell, where contact between bubbles and particles takes place, is in the region of the impeller, whose swept volume is typically of the order of one-tenth of the volume of the flotation cell. Thus a more realistic estimate of the dissipation rate in the active region of the cell is 30 kW per cubic metre, based on the swept volume of the impeller. It is evident that the level of turbulence in such cells is so high that coarse particles are detached from spinning bubbles, leading to low recoveries in the coarse size fractions. To extend the upper limit for the efficient capture of coarse particles by flotation, it is necessary to provide a process in which the specific energy input is much lower than that found in mechanical cells.

Two important concepts relating to the suspension of particles in stirred tanks are the just-suspended impeller speed and the cloud height (Handbook of Industrial Mixing, Edward L Paul et al., eds. Wiley Interscience, New York, 2004). The just-suspended impeller speed is the rotational speed of the impeller that is necessary to suspend the particles off the bottom of the tank, so that no particle remains on the bottom for more than 1 to 2 seconds. When the impeller speed is increased above the just-suspended speed, a well-mixed homogeneous layer is formed in the bottom of the tank. However, it is seen that the particles are not necessarily distributed throughout the whole height of the liquid in the tank, and in some cases a sharp interface is seen, that separates the homogeneous layer in the base of the tank from a clear layer of liquid above. The height of the homogeneous layer is known as the cloud height. When the impeller speed is further increased, the particles are lifted higher and higher until the particle concentration is uniform throughout the vessel. Mechanical flotation cells of known design are operated on the principle that the particles to be floated are fully suspended in the liquid in the flotation cell, and the concentration of particles is as uniform as possible, and essentially independent of height within the cell. Known cells operate with impeller speeds that are well in excess of the just-suspended value, and the contents of the cell are well-mixed and essentially uniformly distributed in the vessel. Thus the cloud height extends essentially to the top of the liquid layer in the cell.

The present invention avoids the need for the particles to be fully suspended in the cell by the impeller, and also the requirement that the cloud height should extend to the top of the liquid in the flotation cell. This invention aims to overcome the drawbacks inherent in mechanical cells, by providing a low-energy environment for flotation that favours the attachment of coarse particles to bubbles.

### SUMMARY OF THE INVENTION

In one aspect the present invention provides a method of separating selected particles from a mixture of particles in a liquid within a flotation cell including the steps of:
feeding the mixed particles and liquid into a mixing zone containing bubbles in a lower part of the cell;
agitating the liquid in the mixing zone to provide a substantially uniform distribution of particles, liquid and bubbles in the mixing zone while providing sufficient fluid flow upwardly through the mixing zone into a fluidization zone above to move the mixed particles upwardly into the fluidization zone;
allowing the selected particles to attach to bubbles within the fluidization zone and rise to the top of the fluidization zone;
allowing bubbles with selected particles attached to rise above the fluidization zone into a disengagement zone while removing other particles from the cell;
forming a froth zone of bubbles and attached selected particles at the top of the disengagement zone; and
removing the selected particles with bubbles from the froth zone.

Preferably, the intensity of agitation in the mixing zone is limited so that a suspension cloud height formed by the agitation does not extend above the mixing zone and into the fluidization zone.

Preferably, the fluidization zone is substantially quiescent and free of any turbulence generated in the mixing zone.

Preferably, the other particles are removed from the fluidized bed.

Preferably, the other particles are removed as tailings from the lower part of the cell.

Preferably, the method includes the step of controlling the level of an interface between the disengagement zone and the froth zone.

Preferably, the method includes the step of controlling the level of the top of the fluidization zone.

Preferably the sufficient fluid flow is provided by feeding the mixed particles and liquid into the mixing zone.

Preferably the sufficient fluid flow is at least partially provided by introducing a fluidizing liquid into the mixing zone.

Preferably the fluidizing liquid is provided by recycling liquid from the disengagement zone into the mixing zone.

Preferably the fluidizing liquid is aerated before being introduced into the mixing zone.

Preferably, the feed of mixed particles is introduced at or below the top of the fluidization zone.

Preferably the liquid is agitated in the mixing zone by rotating a mechanical impeller within the mixing zone.

Preferably bubbles are provided in the mixing zone by drawing air into the mixing zone through the mechanical impeller.

Preferably bubbles are provided into the mixing zone through a porous member or sparger.

In another aspect the invention provides apparatus for separating selected hydrophobic particles from a mixture of particles in a liquid, said apparatus including:
a flotation cell arranged to receive a feed of a mixture of particles and liquid into the lower part of the cell;
fluidization means arranged to supply bubbles and fluid into the cell at such a rate that a fluidized bed of particles is formed in a fluidization zone within the cell;
agitation means operable in a mixing zone below the fluidization zone in the lower part of the cell to provide a substantially uniform distribution of particles, liquid and bubbles in the mixing zone;
a disengagement zone in the cell located directly above and communicating with the fluidization zone such that selected hydrophobic particles attached to bubbles rising to the top of the fluidization zone float upwardly within the disengagement zone;
tailings separation means arranged to remove non-hydrophobic particles from the top of the fluidization zone; and

an overflow launder at the top of the cell arranged to remove the selected hydrophobic particles from a froth layer formed above the disengagement zone.

Preferably, the tailings separation means are arranged to remove non-hydrophobic particles from the top of the fluidization zone.

Preferably, the tailings separation means are arranged to remove non-hydrophobic particles from beneath the disengagement zone.

Preferably, the apparatus includes first level control means arranged to maintain the position of the interface between the froth zone and the disengagement zone within the cell.

Preferably, the apparatus includes second level control means arranged to maintain the position of the top of the fluidization zone within the cell.

Preferably the fluidization means includes a recycle pipe arranged to withdraw liquid from the disengagement zone and pump it back into the mixing zone.

Preferably the recycle pipe includes an aerator arranged to disperse fine bubbles into fluid passing through the recycle pipe.

Preferably the fluidization means includes a porous member or sparger located in the lower part of the cell arranged to supply said bubbles into the cell.

Preferably the agitation means includes a mechanical impeller arranged to be rotated in the mixing zone.

Preferably the fluidization means includes a hollow drive shaft for the impeller arranged to supply air through the hollow drive shaft for dissipation and shear into said bubbles by the impeller.

Preferably the apparatus includes a tailings removal pipe having an intake end positioned at the interface between the fluidization zone and the disengagement zone within the cell.

Preferably the flotation cell has a region of reduced cross-sectional area above the disengagement zone such that the superficial gas velocity in the froth layer formed above the disengagement zone is greater than the superficial gas velocity in the disengagement zone.

In one form of the invention the flotation cell has a region of reduced cross-sectional area above the disengagement zone such that the froth layer formed in the region will have an increased depth.

The invention provides an apparatus for the separation of coarse particles by froth flotation in which contact between bubbles and particles takes place in a fluidized bed. The fluidizing medium is dispersed in the base of the fluidized bed by a rotating impeller, which assists in providing a uniform rising flow of fluidizing liquid and bubbles, and prevents the formation of channels that could lead to bypassing and inefficient use of the bubbles. The apparatus consists of an upright cell or column with means for providing mixing and agitation. New feed and air are introduced into a mixing zone in the base of the column, the air being dispersed into small bubbles by the action of the impeller. The well-mixed feed and dispersed bubbles rise into a fluidization zone, where the bubbles attach to non-wetting particles and carry them upwards into a disengagement or supernatant liquid zone, and thence into a froth zone at the top of the vessel. Tailings are removed from the cell through a pipe or port at the top of the fluidization zone. Means are provided for controlling the position of the top of the disengagement zone at a desired position, and accordingly, the depth of the froth layer in the cell. In alternative arrangements the bed is fluidized by a recirculating flow drawn from above the fluidized bed and injected beneath the impeller. The recirculating flow may be aerated so as to provide the bubbles necessary for flotation.

The particles are suspended by a vertical flow of water in the cell. The superficial velocity of the water is such that it is above the minimum fluidizing velocity of the particles, but below the terminal velocity of a substantial fraction of the particles. When operated in this manner, a liquid-fluidized bed is formed. The weight of the particles is supported by the rising water, and in such a system, the level of turbulence is very low. The concentration of particles in the bed is much higher than is found in conventional flotation cells and consequently, bubbles that rise in the bed must push their way through the particles, making it inevitable that any non-wettable particles in their paths will come into contact with them and form an attachment. Thus the fluidized bed is a highly efficient environment for the separation of non-wetted from wetted particles.

The particles in the flotation feed are maintained in suspension by an upflow of liquid that is essentially uniform across the cross-section of the cell. The superficial liquid velocity in the vertical direction is sufficient to fluidise the particles and keep them separated from each other. Thus when bubbles are introduced into the bed of fluidized particles, they are free to rise in the vessel, and come into contact with hydrophobic particles that lie in their path.

The volumetric fraction of particles in a packed bed where the particles touch and support each other, is usually in the range 0.4 to 0.7. When the bed becomes fluidized, the particles separate from each other and the volume fraction of particles decreases. If the bed is uniform and the volume fraction is constant throughout, the Reynolds number of the flow between the particles is typically well within the laminar flow regime. Accordingly, the flow is quiescent and turbulence is absent. However, in practical liquid-fluidized beds it is difficult to maintain uniformity, and vertical channels tend to develop that allow the suspending fluid to bypass the bed. Once formed, a channel offers a low hydraulic resistance to the flow of the water through the bed, than does the bed itself, and the water that should be supporting the particles in the fluidized bed is instead diverted to flow through the channel, preventing the bed from being uniformly fluidized. When air bubbles are introduced, channel formation is further enhanced.

To gain the advantages of a fluidized bed for the flotation of coarse particles, it is necessary to form the bed in such a way that channelling of gas or water is essentially eliminated. It has been found that a fluidized bed of uniform properties can be achieved by the use of a rotating impeller or agitator in the bottom of the flotation cell. Feed slurry is introduced near the bottom of the cell, and is distributed uniformly by the stirring action of the impeller. The design and operating speed of the impeller are such that a well-mixed zone is created in the bottom of the fluidized bed, but this zone is restricted to the lower regions of the bed. The fluidizing water can be included in the feed entering the cell near the impeller, or it could come from the recycling of liquid taken from above the fluidized bed in the cell. The bubbles may be derived from the dispersion of an air stream that is introduced near the rotating impeller. Clearly, the mixing and pumping characteristics must be such that any turbulence developed by the impeller is restricted to the region at the base of the fluidized bed. To this end, the impeller may be surrounded by baffles that allow a high degree of mixing, but prevent swirling and development of large-scale circulatory motions. The turbulence generated by the impeller is dampened by the high concentration of particles in the fluidized bed, so that in the upper regions of the bed the bubbles are rising through a quiescent environment that is conducive to the maintenance of the attachment between bubbles and hydrophobic particles.

For purposes of clarification, the flotation cell can be described in terms of four zones: a mixing zone, a fluidization zone; a disengagement zone; and a froth layer. In the mixing zone, new feed and bubbles are mixed and dispersed uniformly across the cell. The liquid and bubbles pass into the fluidization zone, where the liquid fluidises the bed and keeps the particles in suspension, while the bubbles pass through the bed, collecting non-wetting particles as they rise. Above the fluidization zone is the disengagement zone that is substantially liquid alone, although it may contain particles that have been entrained in the wakes of the rising bubbles, that disengage from the wakes and fall back into the fluidized bed. At top of the cell is the froth zone, formed by the bubbles carrying their load of attached particles. The froth discharges from the cell as the flotation product.

### BRIEF DESCRIPTION OF THE DRAWINGS

The invention will now be described with reference to the accompanying drawings in which:

FIG. 1 is a schematic cross-sectional elevation of a flotation device according to the invention,

FIG. 2 is a schematic cross-sectional elevation similar to FIG. 1 including an aerated recycle stream.

FIG. 3 is a schematic cross-sectional elevation similar to FIG. 2, illustrating a flotation column in which the flow areas of the fluidization zone and the froth zone are different.

FIG. 4 is a schematic cross-sectional elevation similar to FIG. 3, showing a flotation column in which air is introduced through a porous sparger.

FIG. 5 is a graph of particulate size against recovery percent for fluidized bed apparatus according to the invention compared with a conventional mechanical cell.

### DETAILED DESCRIPTION OF THE PREFERRED EMBODIMENT OF THE INVENTION, AND VARIATIONS THEREOF

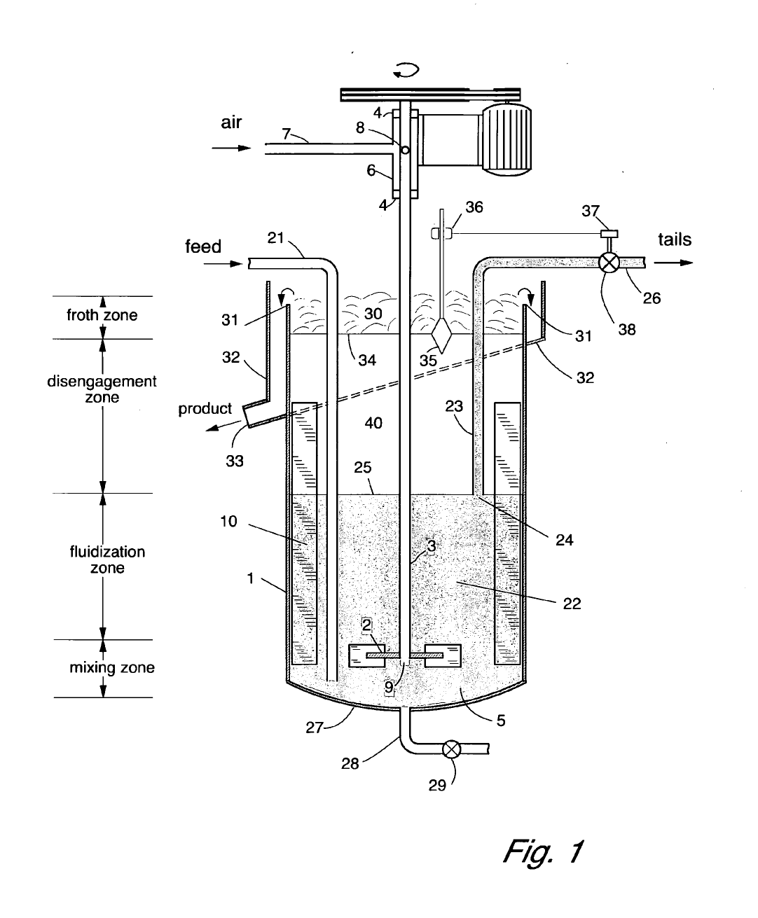

FIG. 1 shows a first preferred embodiment of the invention. A flotation cell 1 is fitted with a rotating impeller 2, which is fixed to a hollow shaft 3 that is attached to bearings 4 that are mounted in a fixed position relative to the cell 1 by means not shown. The shaft 3 rotates in an enclosure 6 into which a controlled flow of air is admitted through the duct 7, which enters the hollow shaft through an opening 8 and flows down the shaft through an opening 9 adjacent the centre of the impeller 2. Baffles 10 are mounted on the wall to prevent swirl. The invention is not limited to any particular type of impeller or baffle design; the latter could include a stator as found in conventional flotation machines.

Conditioned feed slurry enters through the inlet pipe 21, and is delivered into the mixing zone 5 in the base of the cell 1, preferably beneath the impeller 2, which serves to disperse the new feed into the suspension in the bottom of the cell. A fluidized bed or fluidization zone 22 is established in the cell.

A tailings removal pipe 23 is positioned so that its inlet 24 defines the upper boundary 25 of the fluidized bed. Preferably the tailings pipe is mounted so that the position of the inlet 24 relative to the cell 1 can be adjusted in the vertical and horizontal directions, to alter the volume of the fluidized bed and optimise the cell performance for a specific ore. Fluidized particles are withdrawn through the pipe 23 by a syphon or other suitable fluid transmission device not shown, and are discharged as the tailings through the duct 26. In the base 27 of the cell, a discharge pipe 28 and control valve 29 are provided, to allow the cell to be emptied, to permit the periodic discharge of oversize particles that may have accumulated over time in the bottom of the cell, and also as an alternative tailings discharge port.

Bubbles of air laden with captured particles rise out of the fluidized bed 22 to the top of the cell, where a froth layer 30 is formed. The froth flows from the cell over the lip 31 into the launder 32, to discharge through the exit pipe 33 as the flotation product. The froth-liquid interface 34 is maintained by suitable means. As an example, the level could be detected by a float 35 whose vertical position could be measured by a device 36 that sends a signal to an actuator 37 that opens or closes a valve 38 to change the tailings discharge rate so as to maintain the pulp level 34 at the desired position. The invention is not limited to any particular mode of level control.

In operation, a suitably conditioned feed containing particles in suspension enters through the pipe 21, and is discharged into the mixing zone 5 in the vicinity of the impeller 2, where it mixes with the contents of the base of the cell 1. A velocity field is induced in the immediate vicinity of the rotating impeller, which is sufficient to cause local mixing, thereby distributing the new feed so that the upward velocity of particles and water in the cell 1 is essentially uniform across a horizontal cross-section above the impeller. The extent of the homogeneous suspension cloud is limited to the vicinity of the impeller. The upward velocity of the water in the feed is greater than the minimum fluidization velocity of the particles, but less than the terminal velocity, so the particles tend to settle in the cell, forming an expanded fluidized bed above the impeller, with a high concentration of particles. The bed moves slowly upwards under the action of the fluidizing water, towards the entry 24 to the tailings discharge pipe. Because of the presence of the particles, the fluidized bed behaves as if it were a fluid of average density greater than that of water, and a substantially horizontal interface 25 forms at the boundary between the fluidized bed 22 and the supernatant liquor in the disengagement zone 40. The viscosity of the dense fluidized bed is considerably greater than that of water, so the flow field generated by the impeller tends to dissipate quickly, and the influence of the impeller does not penetrate far into the fluidized bed.

Air that enters through duct 7 passes down the hollow shaft 3, and is dispersed into fine bubbles by the action of the rotating impeller 2, which also distributes the bubbles uniformly across the horizontal cross-section of the cell. The bubbles rise through the fluidized bed of particles. The probability of collision between a hydrophobic particle and an air bubble is very high, because the rising bubbles must push the particles away from their path as they rise. Thus the probability of particle capture is also high. The environment is particularly favourable for the capture of coarse particles, because the flow in the fluidized bed is relatively quiescent. The turbulent eddies that exist in known forms of mechanical flotation cell, which tend to cause centrifugal forces that lead to detachment of coarse particles, are essentially absent in the fluidized bed 22 above the impeller. The function of the impeller here is to provide local mixing of feed as it enters the cell, to distribute the air flow into bubbles, and to prevent channelling of water and air rising in the bed. The mixing action of the impeller is restricted to the region surrounding the impeller lower part of the fluidized bed, and does not extend into the lower part of the fluidized bed.

An advantage of the tailings discharge configuration shown in FIG. 1 is that the position of the entry 24 to the tailings discharge pipe determines the height of the fluidized bed. In an alternative arrangement, the tailings are discharged through the exit pipe 28 and a control valve 29 in the base of the cell. A control system not shown is provided to maintain the interface 25 at the top of the fluidized bed 22 and the liquid level 34, at their desired positions. In the alternative configuration, the level of the interface 25 at the top of the fluidized bed could be detected by a float of appropriate density, or a differential pressure sensor suitably positioned in the cell. In a further alternative arrangement, tailings are removed at any point below the top 25 of the fluidized bed through a standpipe not shown, that is connected to the exit pipe 28 and the control valve 29.

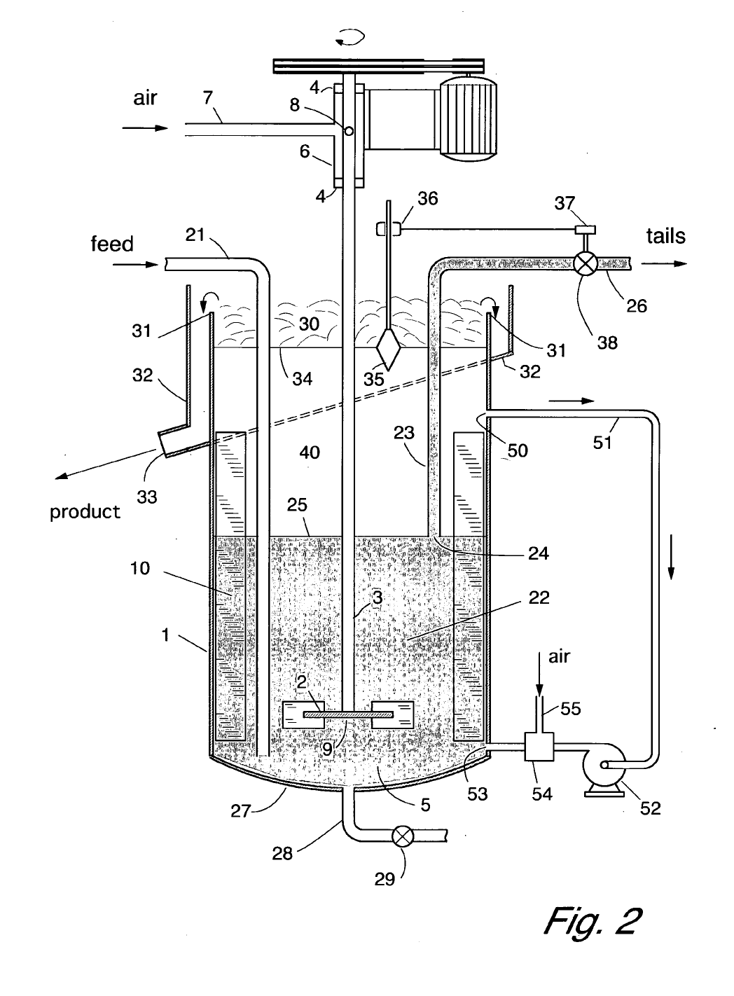

An alternative preferred embodiment is shown in FIG. 2. The apparatus is essentially the same as depicted in FIG. 1, with additional features that permit the recycling of the supernatant liquid from the disengagement zone 40 within the fluidized bed. Thus the cell 1 is provided with an exit port 50, a recycle pipe 51, a pump 52, and a re-entry port 53. In a further preferred embodiment, an aerator 54 is provided in which air that enters through the pipe 55 is dispersed into fine bubbles within the recycle stream. When air bubbles are introduced through the use of the recycle stream, it is not necessary to use the impeller as the means for making small flotation bubbles. It is often found that the rotational speed necessary to make small bubbles in the region of the impeller 2 is greater than the speed necessary to distribute the fluidizing water and to prevent the formation of channels in the fluidized bed. In general it is preferable to operate the impeller at the lowest speed possible, to conserve energy and to minimize the turbulence generated by the impeller in the fluidized bed. Thus where possible it is preferable to use the recycle stream for the introduction of the bubbles.

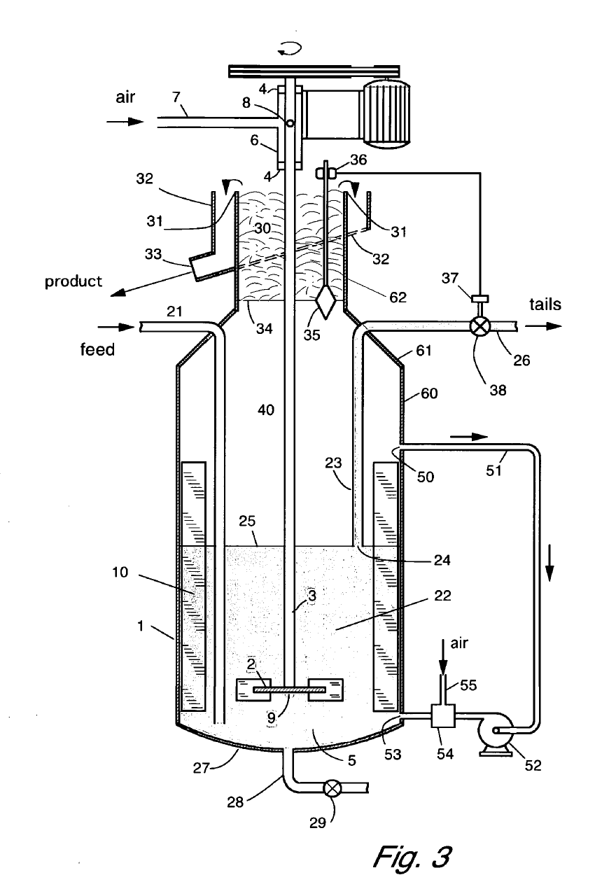

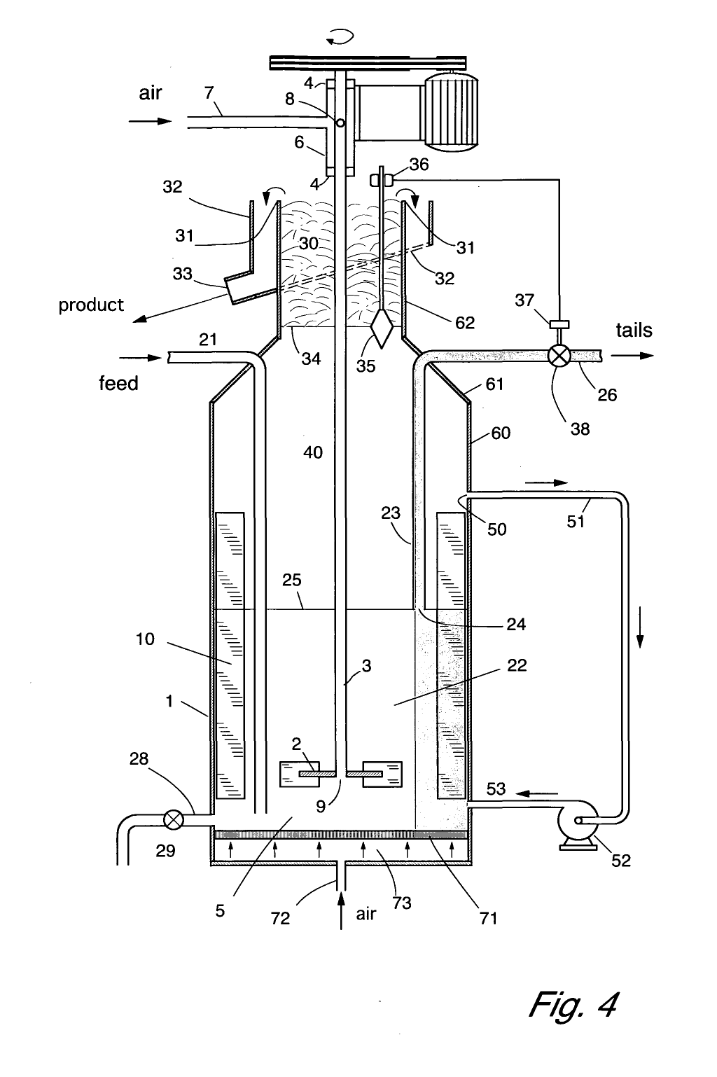

Although the alternative embodiment shown in FIG. 2 has the air inlet through duct 7, down the hollow shaft 3 and dispersion by the action of the rotating impeller 2 also shown, it will be appreciated that this part of the apparatus could be omitted where sufficient aeration is provided via the aerator 54. It has been left in FIG. 2 for convenience as it is possible that both methods of introducing bubbles could be used at the same time, and a similar situation applies to the further embodiments described later with reference to FIG. 3 and FIG. 4.

In operation, supernatant liquid from the disengagement zone 40 enters the port 50 and passes through the recycle pipe 51 under the action of the pump 52. The recycle flow enters the base of the cell 1 in the region of influence of the impeller 2, and mixes with the particles in the mixing zone 5 of the cell. The combined flow of new feed from the pipe 21 and the recycled liquid, is dispersed across the cross-section of the cell, and the water in the combined flow percolates upwards through the fluidized bed.

In the absence of recycle, the flow of new feed to the flotation cell may fluctuate or may stop altogether, in which case the supply of the water necessary to suspend the particles in the fluidized bed will cease. The advantage of the use of the recycled flow, is that an upflow of water through the bed can be maintained, independent of the flowrate of new feed, and assisting in stable operation of the bed. The particles in the feed tend to settle in the fluidized bed, so the supernatant liquid in the disengagement zone 40 has a higher proportion of finer particles and water, than is found in the feed stream. The recycled water assists in the action of the impeller in the base of the cell, and also in the maintenance of the bed in a fluidized state.

A further advantage is gained if air in the form of fine bubbles is dispersed into the recycle stream in an aerator 55. The recycle flow enters the recycle pipe 51 through the port 50, which is located above the fluidized bed. The recycle stream may contain particles that have been elutriated from the fluidized bed by the flushing action of the additional water included in said stream. In the aeration device 54, such particles will attach to air bubbles prior to entry into the fluidized bed, assisting them to rise through the cell and pass into the froth layer 30, to be recovered with the flotation product. Thus the use of aeration into the recycle stream will lead to improved recovery of particles in the cell. The invention is not limited to any particular aeration device, of which there are a number of known examples available in the marketplace. For optimum results, the recycle circuit with aeration should be designed to suit the particular characteristics of the chosen aeration device, with regard to bubble size, residence time and internal shear rate.

In the embodiment shown in FIG. 1, it is necessary to introduce the feed liquid into the base of the flotation cell, so that it may rise and fluidize the bed of particles. It will be appreciated that in the embodiment shown in FIG. 2, all the fluidizing liquid can be provided by the recycle stream, so there is no necessity to introduce the new feed into the bottom of the flotation cell. Accordingly, the new feed may enter at any position. This feature may be advantageous when operating with systems in which the feed contains some hydrophobic particles that are of much lower density than the material to be rejected in the flotation process. Such particles may in any case rise to the top of the fluidized bed. When the feed mixture is directed to the top of the fluidization zone, the tailings may be removed from the base of the fluidization zone, or from the mixing zone.

Another advantage of the use of a recycle stream as shown in FIG. 2 relates to the behaviour of very fine particles in the fluidized bed. Although the superficial liquid velocity in the bed is maintained at a value that is sufficient to fluidize a substantial fraction of the particles, the very fine particles that may exist in a practical feed would tend to be elutriated out of the fluidized bed. In the embodiment shown in FIG. 2 such particles would be recycled back to the bottom of the fluidized bed and they would also have the opportunity to be contacted with air bubbles in the aeration device. Thus the recycle stream with aeration provides an effective means for increasing the efficiency of capture of the finest particles in a flotation feed stream.

Part of the liquid needed to fluidise the contents of the flotation cell 1 in FIG. 2 has been provided by the recycle stream which passes through an exit port 50, a recycle pipe 51, a pump 52, and a re-entry port 53. It will be appreciated that the use of a recycle stream is only one of a number of ways in which the fluidizing liquid could be provided. Thus liquid could be drawn from another part of the flotation circuit of which the cell forms a part or it could be created from a fresh water supply. It could also be supplied as additional dilution water in the feed pulp to the flotation cell.

Another preferred embodiment of the invention is shown in FIG. 3. The apparatus is essentially the same as depicted in FIG. 2, with the additional feature that the horizontal cross-sectional area of the froth zone 30 is smaller than that of the fluidization zone 22. Thus the vertical wall 60 of the fluidization zone 22 and the disengagement zone 40 is surmounted by a conical reducing section 61 that connects to the base of a second compartment 62 with vertical walls enclosing the froth zone 30. It will be appreciated that the flowrate of gas admitted to the flotation cell is constant, so the superficial gas velocity, which is the gas flowrate divided by the flow area, is higher in the froth zone 30 than in the fluidization zone 22. This feature provides flexibility in the operation of the cell, in that the velocity requirements in the two zones may not be the same. It is particularly beneficial for the recovery of coarse particles, to operate the froth zone with relatively high gas superficial velocities, in the range 2 to 4 cm/s, while the optimum value in the fluidized bed may be in the range 0.5 to 1 cm/s. By providing a smaller cross-sectional area in the froth zone it is possible to maintain a higher gas velocity there while operating with a lower value in the fluidization zone. The reduction in froth area could also be obtained by the use of froth crowding which is a known technology. Although the reduced-area feature is described with reference to an embodiment incorporating a recycle liquid stream as shown in FIG. 2, it will be appreciated that the same feature could with advantage be applied to the arrangement shown in FIG. 1 that does not incorporate a recycle stream.

In the embodiments shown in FIGS. 2 and 3, air is dispersed into the recycled liquid in the aerator 54. The bubbly liquid passes into the cell 1 into the mixing region 5 in the vicinity of the impeller. In some circumstances, for example when the recycle liquid may contain large particles that could potentially block the aerator, it may be preferable to introduce the bubbles through a porous sparger or distributor in the base of the cell itself. In the alternative preferred embodiment shown in FIG. 4, the cell is fitted with a porous member 71. Air under pressure flows through the entry pipe 72 into the distribution chamber 73, and then through the porous member 71, issuing into the contents of the flotation cell in the form of fine bubbles in the region 5 in the vicinity of the impeller 2. A flow of fluidizing liquid is maintained by the circulation pump 52. The bubbles mix with recycle liquid and rise upwards through the fluidized bed. In the embodiment shown in FIG. 4, the main features of the embodiment shown in FIG. 3 have been retained, particularly with reference to the reduction in column area in the froth zone. It will be appreciated that the distribution of air through the porous sparger shown in FIG. 4 can be used with advantage in the embodiments shown in FIG. 1 and FIG. 2. Although the means for the production of fine bubbles is depicted in FIG. 4 as a porous plate that extends essentially across the vessel 1, other forms of sparger could be used, such as tubes or ducts with porous walls or with suitably-placed orifices; or known proprietary devices for the introduction of bubbles into flotation columns.

### Example

A flotation cell was constructed according to the invention, and operated in batch mode. A sample of high-grade galena was used as the floatable material, and it was mixed with graded silica particles as a source of non-floatable material. The galena was crushed and sieved to provide a sample in the size range 45 to 1400 micrometres. The silica was in the size range 250 to 710 micrometres. The galena:silica mass ratio was 1:19 and the sample volume was 1.05 litres. The cell diameter was 100 mm, with a froth zone of diameter 63 mm and height 150 mm. The overall height of the cell was 920 mm. The cell was fitted with an impeller of diameter 70 mm operating at 150 rpm, with a tip speed of 0.55 m/s. When fluidized with recirculation fluid a clear transition could be seen through the transparent cell wall, between the top of the fluidization zone and the disengagement zone. The contents of the cell were fluidized with fluid taken from the disengagement zone and recycled through a bubble generator to enter the cell in the mixing zone beneath the impeller. Xanthate (45 g/tonne) was used as collector and MIBC (25 ppm) as frother. The ore was conditioned for 15 mins at a pH of 8.5 prior to flotation. Air was supplied at a rate of 2 L/min. The liquid level in the cell was maintained at a position 120 mm below the lip of the cell, by the addition of make-up water. The flotation product was collected, until no further particles appeared to be discharging from the cell.

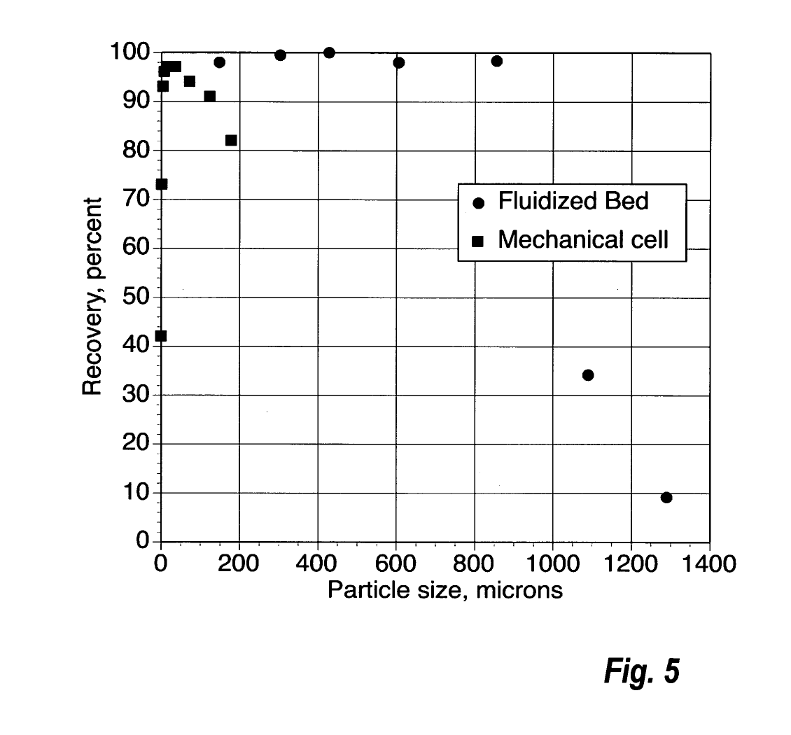

The results of the flotation test are shown in FIG. 5, where for purposes of comparison, data for the flotation of galena in a mechanical cell are shown (from Jowett, A., 1980. Formation and disruption of particle-bubble aggregates in flotation. In Fine Particles Processing (Ed. P. Somasundaran), pp 720-754 (American Institute of Mining and Metallurgical Engineers: New York)). Jowett's results are typical of data for mechanical cells. It can be seen that the recovery is quite low for ultrafine particles, and as the particle size increases, the recovery increases, to reach a maximum of 97 percent at a size of 60 μm; for larger sizes the recovery decreases rapidly. With the fluidized bed cell according to this invention, the recovery remained at essentially 95-100 percent for particle sizes up to 850 μm, beyond which there was a gradual decline. The results show that the range of particle sizes of galena particles recovered by flotation can be extended more than ten-fold through the use of a fluidized bed flotation cell according to this invention.

1. A method of separating selected particles from a mixture of particles in a liquid within a flotation cell including the steps of:
feeding the mixed particles and liquid into a mixing zone containing bubbles in a lower part of the cell;
mechanically agitating the liquid in the mixing zone to provide a substantially uniform distribution of particles, liquid and bubbles in the mixing zone while providing sufficient fluid flow upwardly through the mixing zone into a fluidized bed above to move the mixed particles upwardly into the fluidized bed;
allowing the selected particles to attach to bubbles within the fluidized bed and rise to the top of the fluidized bed;
allowing bubbles with selected particles attached to rise above the fluidized bed into a disengagement zone while removing other particles from the cell;
forming a froth zone of bubbles and attached selected particles at the top of the disengagement zone; and
removing the selected particles with bubbles from the froth zone.

2. A method as claimed in claim 1 wherein the intensity of agitation in the mixing zone is limited so that a suspension cloud height formed by the agitation does not extend above the mixing zone and into the fluidized bed.

3. A method as claimed in claim 1 wherein the fluidized bed is substantially quiescent and free of any turbulence generated in the mixing zone.

4. A method as claimed in claim 1 wherein the other particles are removed from the fluidized bed.

5. A method as claimed in claim 1 wherein the other particles are removed as tailings from the lower part of the cell.

6. A method as claimed in claim 1 including the step of controlling the level of an interface between the disengagement zone and the froth zone.

7. A method as claimed in claim 1, including the step of controlling the level of the top of the fluidized bed.

8. (canceled)

9. A method as claimed in claim 1 wherein the sufficient fluid flow is at least partially provided by introducing a fluidizing liquid in the form of recycled liquid from the disengagement zone into the mixing zone.

10. (canceled)

11. (canceled)

12. (canceled)

13. A method as claimed in claim 1 wherein the liquid is agitated in the mixing zone by rotating a mechanical impeller within the mixing zone.

14. A method as claimed in claim 13 wherein bubbles are provided in the mixing zone by drawing air into the mixing zone through the mechanical impeller.

15. A method as claimed in claim 1 wherein bubbles are provided into the mixing zone through a porous member or sparger.

16. Apparatus for separating selected hydrophobic particles from a mixture of particles in a liquid, said apparatus including:
a flotation cell arranged to receive a feed of a mixture of particles and liquid into the lower part of the cell;
fluidization means arranged to supply bubbles and fluid into the cell at such a rate that a fluidized bed of particles is formed within the cell;
a mechanical agitator operable in a mixing zone below the fluidized bed in the lower part of the cell to provide a substantially uniform distribution of particles, liquid and bubbles in the mixing zone;
a disengagement zone in the cell located directly above and communicating with the fluidized bed such that selected hydrophobic particles attached to bubbles rising to the top of the fluidized bed float upwardly within the disengagement zone;
tailings separation means arranged to remove non-hydrophobic particles from the cell; and
an overflow launder at the top of the cell arranged to remove the selected hydrophobic particles from a froth layer formed above the disengagement zone.

17. Apparatus as claimed in claim 16 wherein the tailings separation means are arranged to remove non-hydrophic particles from the top of the fluidized bed.

18. Apparatus as claimed in claim 16 wherein the tailings separation means are arranged to remove non-hydrophobic particles from beneath the disengagement zone.

19. (canceled)

20. (canceled)

21. Apparatus as claimed in claim 9 wherein the fluidization means include a recycle pipe arranged to withdraw liquid from the disengagement zone and pump it back into the mixing zone.

22. Apparatus as claimed in claim 21 wherein the recycle pipe includes an aerator arranged to disperse fine bubbles into fluid passing through the recycle pipe.

23. Apparatus as claimed in claim 16 wherein the fluidization means includes a porous member or sparger located in the lower part of the cell arranged to supply said bubbles into the cell.

24. Apparatus as claimed in claim 16 wherein the agitation means includes a mechanical impeller arranged to be rotated in the mixing zone.

25. (canceled)

26. Apparatus as claimed in claim 16 including a tailings removal pipe having an intake end positioned at the interface between the fluidized bed and the disengagement zone within the cell.

27. Apparatus as claimed in claim 16 wherein the flotation cell has a region of reduced cross-sectional area above the disengagement zone such that the superficial gas velocity in the froth layer formed above the disengagement zone is greater than the superficial gas velocity in the disengagement zone.
